(19) United States
(12) Patent Application Publication
(10) Pub. No.: US 2019/0177941 A1
(43) Pub. Date: Jun. 13, 2019

(54) FLOODBAG SANDLESS SANDBAG

(71) Applicant: Thomas Ralph Rossi, Newport Beach, CA (US)

(72) Inventor: Thomas Ralph Rossi, Newport Beach, CA (US)

(21) Appl. No.: 16/280,013

(22) Filed: Feb. 19, 2019

Related U.S. Application Data
(63) Continuation-in-part of application No. 14/617,355, filed on Feb. 9, 2015, now abandoned.
(60) Provisional application No. 62/765,395, filed on Aug. 22, 2018.

(51) Int. Cl. E02B 3/10; B01J 20/24

(52) U.S. Cl. CPC E02B 3/108; B01J 2220/445; B01J 2220/4825; B01J 20/24

(57) ABSTRACT

The invention includes a defense against flooding, with a flexible, outer shell, with absorption holes, and, inside the outer shell, one or more water-absorbing components that expand when absorbing water. The outer shell can be hydrophobic. The water-absorbing components can be compressed wood pellets. Also inside the outer shell can be a hydrophobic, but oleophilic, inner component that absorbs hydrocarbon molecules penetrating through the absorption holes. The water-absorbing components do not absorb hydrocarbons in some embodiments, In other embodiments other components mat be added that target and absorb other substances. In the first embodiment, the compressed wood pellets can be discarded easily after they have absorbed water and been expanded. In the first embodiment, the hydrophobic outer shell and oleophilic inner component are both made of polypropylene. Several specialized versions of the sandless sandbag, called hereafter a “FLOODBAG”, and also methods of using the FLOODBAG, a replacement for sand bags are also included in the invention, as is a method for making specialized FLOODBAGs.

### DESCRIPTION OF THE RELATED ART

This patent application claims priority to U.S. Provisional Application 62/765,395, filed Aug. 22, 2018, with Thomas Ralph Rossi as the inventor. This patent application also claims priority to another U.S. patent application mailed to the USPTO in January 2019 with Thomas Ralph Rossi as the inventor, and an updated Application Data Sheet will be filed, when Mr. Rossi learns the application number of this second provisional patent application. This patent application also claims priority to currently pending patent application Ser. No. 14/16755 with Thomas Ralph Rossi as the inventor. The “sandless sandbags” otherwise known as “FLOODBAGS” of the present invention will include, at a minimum, the outer shell and the compressed wood pellets within the outer shell. For purposes of this application, a “conventional sandbag” will be a sandbag filled with sand, earth, or dirt.

Systems for controlling sudden inundations of water, such as floods, and storm surges, have always been a necessary part of human civilization. If a large amount of water suddenly threatens to enter a building, such as a torrent of water from a flooded street, the structure of the building, and whatever is inside the building, may be vulnerable to water damage. Outdoor areas such as farmland, parking lots, and roadways can also be vulnerable to damage from flooding. For example, floods can sweep away crops growing on farmland. A large rainstorm or other sudden influx of water can also make a street or a parking lot impassable by depositing a large amount of water on the street or parking lot.

Areas, and buildings, not normally under threat from flooding, may be suddenly threatened by floods during sudden rainfall. For example, desert areas like Las Vegas are vulnerable to water damage from rain storms of 3-4 inches or more, because parts of the infrastructure of these areas are not designed to deal with such storms. Larger storms are also possible, in areas like Las Vegas, with proportionately greater risk of water damage.

In San Bernardino, Calif., and parts of Los Angeles, Calif., and other cities, exceptionally large rainstorms can temporarily turn streets into “rivers” as large amounts of rainwater floods into a street, threatening water damage to areas and structures alongside that street, and making the street difficult or impossible for pedestrians to pass through. Rainstorms can also cause water to intrude into garages and buildings alongside the street. This problem is not unique to southern California, but is present in other areas, as well.

Other areas, such as Miami, experience frequent rainstorms, with an attendant possibility of water damage from these rainstorms.

Large rain storms, in general, can also threaten temporary flooding. For example, in Beverly Hills, Calif. large rainstorms have caused water damage to buildings and damage to other outdoor areas.

Many areas, including parts of California may also be threatened by floods as a result of structural failures of dams, levees, and other infrastructure that is normally functional, but is damaged by an earthquake or other natural disaster. For example, at least one dam in Los Angeles would have collapsed in the 1971 Sylmar earthquake, if the water level in the reservoir related to that dam had not been lowered a few days before the earthquake.

In general, areas such as New Orleans and other coastal and/or low-lying areas are under threat from sudden floods caused by hurricanes and other storms, such as Hurricane Katrina in 2005. Other coastal and/or low-lying areas, such as the Mississippi flood plain areas are vulnerable to storm surges and other sudden flood conditions, such as a nearby river overflowing its banks. Even when infrastructure exists to stop floods, it may not have been properly maintained, such as in New Orleans in 2005, where the levees designed to stop flooding were not properly maintained, and in New York City (briefly), on one occasion when the pumps to pump water out of the subway system were not maintained, and parts of the subway system had to be shut down for a day while the pumps were repaired.

The southern California fires in 2018 created a risk of flooding on the hillsides and other areas that the fires had denuded. This problem is exacerbated in areas downstream from burned areas, because a burned area will have few plants to hold the topsoil down, and water is more likely to flow quickly over a burned area to other areas downstream. A method of quickly controlling such floods is necessary, and this method should be easy to deploy, because the exact area where a flood will happen often cannot be predicted far ahead of time, and so the method of controlling such floods must be deployed, on short notice, in areas where floods are expected to happen.

Some areas are also vulnerable to sudden inundations of water from melting snow. The melting snow can carry salt, because in some areas such as the American Midwest salt is used to melt snow and ice on roads.

In general, buildings, and other areas including, but not limited to, playgrounds, yards, and many public areas, are in danger from sudden damage created by sudden inundations of water. For example, a flower garden can be destroyed by temporary flooding, while nearby buildings that are slightly more elevated than the flower garden may be unaffected by the temporary flood.

It should be noted that a “sudden inundation of water” might be a flood, but might also be much smaller than what is generally considered a “flood”. For example, melting snow from a driveway can threaten damage to areas such as gardens near the driveway, can flood into basements through open windows and cracks, and also carry hydrocarbons and other contaminants such as salt from the driveway to other areas.

There are also many locations where water that is contaminated with a dangerous compound is stored, or simply accumulates. For example, water that accumulates in a pond on an old industrial site may become contaminated by chemicals or metals that were used at that industrial site. If a large amount of water from some new source (such as a rainstorm) then enters the pond, the water in the pond, and the contaminants, may spill out, flow somewhere else, and contaminate another area.

An intrusion of water might comprise water flowing into an area where the water is not supposed to be; For example a toilet overflowing might cause an intrusion of water. An intrusion of water is a subtype of inundation, for purposes of this patent application.

In all of the cases above, and in many other cases, there needs to be a method of controlling sudden inundations and intrusions of water and preventing this water from causing damage within buildings or to outdoor areas. The exact locations where there is a risk of flooding or water damage will not be obvious, ahead of time, in each case, so this method should be easy to move and deploy, to increase the chances it will be deployed when needed. Ideally, this method should also remove contaminants that are present in the water.

Mining companies use large amounts of water for various purposes, such as cyanide extraction ponds in gold mining operations. The water in a cyanide extraction pond must be confined in the pond, because it is toxic.

In 1995, about 4 million cubic meters of waste was accidentally allowed to reach the Essequibo River in Guyana, killing some of the marine life there. A better method of quickly controlling accidental discharges of contaminated water from mining operations, including, in particular, accidental discharges of water from cyanide extraction ponds, must be found. This method should be as easy to deploy as possible, to address unexpected discharges of contaminated water when they happen.

The interior of a home or other building can also be damaged by “rogue” water appearing in an area that is not designed to accommodate water. Wood floors, carpets, and other areas can be damaged by relatively small intrusions of water. Furniture can also be damaged by small amounts of water. The damage from even an inch of standing water, remaining in a room for one day, can amount to thousands of dollars.

The average flood insurance damage claim amounts to $42,000 in the U.S. Homes and office buildings can suffer large amounts of damage from even small amounts of standing water.

Sudden, relatively small inundations of water in the interiors of buildings can come from many sources, including, but not limited to, pipes bursting, toilets overflowing, and rain penetrating through holes in a roof. An office building, for example can experience thousands of dollars in damage resulting from a pipe burst causing a few inches of water to be released into one room of the office building.

Other sources of relatively small water inundations include water coolers malfunctioning, or items such as drinks being spilled, for example, a large amount of water being spilled on a desk, where a computer or other electronic equipment is located.

Many houses have basement windows that lead to a basement that is below ground level. Because water flows down, a relatively small amount of water, for example, from melting snow, can flow through a basement window, become standing water in the basement, and cause water damage to the structure, and equipment such as furnaces, and stored goods.

In multistory buildings, including many office buildings, apartments, and dormitories, a sudden inundation such as a pipe breaking in one unit, or one or more windows being blown through during a storm, can cause damage to neighboring units and occupants.

A long-felt, but unsolved need therefore exists for a method of quickly controlling sudden inundations of water, such as natural and artificial floods, but also including smaller inundations of water.

In some areas, such as the Netherlands, dikes protect areas below sea level, but the dikes sometimes develop small holes, allowing water to seep through. A method of stopping these leaks quickly and cheaply is needed. The method should be as easy to deploy as possible, because the locations of these leaks are not predictable ahead of time.

The method should be quickly controlled and deployed, for example, because in many cases there may not be time or resources available to move a more slowly deployed method into position to stop a sudden influx of water. The method should also be useful when a sudden inundation or intrusion of water happens indoors or outdoors.

### Mobile Barriers

Mobile barriers are the most common method of controlling sudden inundations such as floods. A mobile barrier physically limits the inundation from advancing any further.

In practice the best known and most widely used mobile barrier is the sandbag. Sandbags, generally refer to sacks made of hessian/burlap, polypropylene, or like materials, which are filled with sand or soil. The sandbags may be brought in empty to a location where a flood is occurring, or may potentially occur, and filled on site with local sand or soil. Once filled, the sandbags may be placed, and in some cases stacked in multiple levels, along a boundary of a body or expanse of water, such as, for example, a river bank. Sandbags generally tend to prevent or at least reduce the effects of a flood. Online searches indicate recommendations for weight of sandbags being approximately 30 pounds. However, some fillers create sandbags which weigh up to 60 pounds, which are more difficult to move. This also causes extra physical stress for the people moving the sandbags, and potential damage to their bodies. Conventional sandbags are, by their nature, cumbersome and heavy.

The delivery of bags filled with sand or soil to the site where a flood threatens, and their removal after the flood has passed, is costly, labor intensive, creates added risk of injury, and there is a possibility that the truck or other vehicle carrying sandbags will get bogged down or otherwise be unable to move before it reaches the place where the sandbags are needed. The piling of sandbags to form a barrier is also time- and labor-intensive. Each bag generally needs to be filled with sand or soil on site, which may take a significant amount of time. A source of sand or soil must also be available. Therefore, effective deployment of sandbags is curtailed by the facts that sandbags require a large amount of time and labor to deploy, and require a specialized material, sand, or soil, which is not always available. Additional damage can also happen during the time required to deploy conventional sandbags. This also makes stockpiling sandbags for future use impractical in many situations. For example, an apartment dweller or apartment building cannot usually stockpile sandbags for future use to deal with emergencies related to the building's plumbing system, or floods caused by the weather, because 100 conventional sandbags can weigh approximately 3000-6000 pounds, and the conventional sandbags will take up too much space while they are being stored for future use. Further, the challenge of moving around a palette of 100 conventional sandbags weighing up to 6000 pounds far exceeds the more minimal effort required to move a palette of 200 FLOODBAGs weighing up to 1400 pounds. In addition, a person operating a palette-jack can move a palette of FLOODBAGs around more easily than a palette of conventional sandbags. This is important in all cases, but especially when trying to deploy FLOODBAGs in a large number of separate locations, such a large number of offices or apartments in a building.

The sheer size of conventional sandbags also makes them impractical even to use to stop inundations and intrusions of water in some confined areas such as apartment buildings and offices.

If a source of sand is not available on-site, the sandbags will have to be filled up elsewhere and then moved to the place where they are needed to form a barrier. This is also time-consuming, labor-intensive, and also requires fuel and other costs, to move the sandbags. This plan also requires labor to build a barrier with the sandbags, when they arrive at the destination where they are needed, and this also causes physical damage to the people working to build the barrier.

In addition, once a sandbag is deployed, it is hard to move, because a sandbag is designed to be heavy, and stops water because it sits in the way of the water, and is heavy and therefore hard to move. Therefore, if a sandbag is placed in a location where it is not needed as thought, the sandbag cannot be moved easily. If the person or entity placing the sandbag finds that the sandbag needs to be moved to another location to stop flooding, that person or entity must then move the sandbag to the other location.

A related problem is that sometimes when a crew of workers is building a wall of sandbags, they suddenly learn that the most urgent danger from flooding is not in the place where they are building, but in some other location, and they then have quickly to move the sandbags to the other location. For example, a crew can be building a wall of sandbags in one place, only to be told that the sandbags are not needed in that location, but really needed 100 yards away. They therefore now must move the sandbags 100 yards away. A truck may not be able to negotiate the terrain or boggy soil conditions to move the conventional sandbags.

Moving and piling sandbags also often causes physical damage to the people moving and piling the sandbags, simply because repeatedly lifting heavy sandbags leads to increased possibility of back injuries and other injuries, along with necessary Workman's Compensation costs.

Another problem with conventional sandbags is that they can be environmentally destructive to create. For example, when trying to make sandbags to deal with an emergency, on a denuded hill (such as the hills in parts of Los Angeles County after the Fall 2018 fires or Winter 2017 fires), a crew will have to dig a hole to get the sand or dirt to fill the sandbags. This disrupts the topsoil and accelerates erosion. A crew might also be required to carry the sandbags uphill to denuded or bare hillside otherwise inaccessible by vehicle and fill them there, instead of filling them at the base of the hill, and then carrying the now-heavy conventional sandbags uphill. However, this creates gashes in the hillside that lead to the possibility of landslides later, and also accelerates erosion and risk of injury due to the physical stress associated with filling and carrying heavy sandbags.

Another problem with conventional sandbags is that once they are used to build a barrier, more labor and resources are required to move or remove the sandbags once the threatened inundation recedes. Removing a wall made out of conventional sandbags and moving the conventional sandbags often requires a comparable amount of energy and labor to that expended to build the wall out of conventional sandbags in the first place.

The above-described characteristics of conventional sandbags also mean that the present invention can be used to create a much faster response to a threatened inundation than conventional sandbags. The present invention can also be used to create a barrier scaled to the size of the relevant threatened inundation more easily than conventional sandbags. FLOODBAGs of the present invention, which have not yet become very wet, can be more easily transported to the location of another threatened inundation and re-used much more easily than conventional sandbags.

Another related problem with conventional sandbags is that in many emergency situations, such as large storms, hurricanes, and earthquakes, the emergency services will be preoccupied, and will not be able to quickly get sandbags to the places where they are needed. Volunteers also may not have the type of training needed to fill the sandbags and/or use them to build barriers.

The present invention allows individual households and businesses to stockpile the FLOODBAGs of the present invention much more easily, use the FLOODBAGs to create a barrier when needed more easily and quickly, and then store FLOODBAGs that have not contacted water for use later.

This is especially important in cities such as Los Angeles and San Francisco, which expect to experience major disasters at some point in the future. Los Angeles' City Government has tried to give neighborhoods tools to quickly respond to disasters, because, in a disaster, City services may be occupied and unable to help some neighborhoods quickly. Individual homeowners, apartment buildings, condominium buildings, schools, churches and other religious foundations, and neighborhoods can therefore stockpile the FLOODBAGs of the present invention much more easily than they can stockpile conventional sandbags, because the FLOODBAGs are lighter and take up less space than conventional sandbags. An individual homeowner or apartment building can then deploy the FLOODBAGs of the present invention much more quickly than a City agency can deploy conventional sandbags. When sand is stored, it is often stored outside, which makes the sand wet, when it rains. Furthermore, wet sand makes conventional sandbags filled with that sand heavier, which in turn exaggerates the previously mentioned problems with Workman's Comp. injuries, etc. It requires more labor and energy to fill conventional sandbags with wet sand, instead of dry sand.

This is also important in areas such as Carpinteria, Montecito, and Santa Barbara, Calif., which are very hilly and in danger, during heavy rainstorms, from issues such as rain turning hillsides into mud and causing mudslides. The present invention allows a homeowner or other resident in one of these areas to quickly create a barrier in a location where it is needed. The FLOODBAGs in the barrier will then swell, when exposed to water, to the same size as conventional sandbags, hopefully creating a barrier to a mudslide. If it is determined there could be heavy flow, pyramidal walls could quickly be built using the present invention in order to provide greater protection against that heavy flow.

An individual homeowner, or renter, can also order the FLOODBAGs of the present invention online or through other means, and have them delivered to a home or a workplace within a day or two, to be stockpiled for an emergency.

The FLOODBAGs will also be hugely helpful to municipal or other government agencies, because individual residents will be able to order the FLOODBAGs whenever they wish, possibly very far ahead of time, and then use the FLOODBAGs when needed, without putting a strain on government agencies.

Institutions such as schools and businesses can also easily include FLOODBAGs in their “disaster preparedness kits” much more easily than they can include conventional sandbags.

### Other Types of Mobile Barriers

Other types of mobile barriers and methods of stopping flooding have been discussed, but none of these are similar to the present invention. None of these also provide the type of capacity for a rapid response, ease of movement, less physical stress, especially for elderly or infirm, etc, scaled to the level of the threatened inundation, with the possibility of reusing unused bags, that the present invention provides. None of these also provide the capacity to stop a sudden inundation and clean up other pollutants, such as hydrocarbons and other contaminants, that the present invention provides.

Several patents discuss large, mobile barriers, but these all function using different principles from the present invention.

U.S. Pat. No. 9,562,335 involves wood support sheets, but these are completely different from the compressed wood pellets in the present invention. The compressed wood pellets in the present invention are supposed to absorb water, thus facilitating the invention's present purpose of absorbing water to control floods and other sudden inundations of water. The wood support sheets in U.S. Pat. No. 9,562,335 are supposed to provide structural support so that other components of the invention can stand up.

The combination of principles which underlie the “sandless sandbags” or FLOODBAGs means that the invention described in this patent application can be used to create customized FLOODBAGs with content that is optimized for the characteristics of a specific environment, such as an oil spill in a specific place.

U.S. Pat. No. 9,562,335 also notes that earth is sometimes used as filler for sandbags, but earth has different characteristics from compressed wood pellets used as filler in the present invention. For example, the compressed wood pellets are different, in terms of composition, from earth. The compressed wood pellets also expand much more than earth does, when placed in water. This is an essential characteristic of the present invention, because the fact that the present invention is relatively lightweight when transported is one of the reasons the present invention is useful.

U.S. Pat. No. 8,956,077 involves a barrier which is made of a light, flexible material that can include nanofiber. Some embodiments are formed from a plurality of interlocked water-filled cells, with a forward-facing water barrier sheet. Other embodiments are unitary shells that are internally divided into cells, with internal openings that permit water to flow between cells. The barrier fulfils a different purpose from any part of the present invention.

U.S. Pat. No. 4,418,163 discusses use of resin, as the filler for the sandbags, but resin is not the same thing as compressed wood pellets, because it is chemically different from compressed wood, and resin is not as biodegradable as compressed wood that is decompressed after water absorption. Furthermore, the size and volume of the compressed wood pellets of the present invention is lowered by the compression process, while the resin in U.S. Pat. No. 4,418,163 is not compressed, and does not have any lower volume or weight than it would have normally. This is an important advantage of the present invention over the invention of U.S. Pat. No. 4,418,163.

U.S. Patent Application 20130309011 by Glodak discusses use of sandbags filled with a water-absorbing polymer, that can be made bigger and then stacked, but this is very different from the present invention, most embodiments of which use compressed wood pellets as a filler for sandbag, and to absorb water. The present invention also relies on the fact that wood is biodegradable to make disposal of the compressed wood pellets easier, after the present invention is used. This is a different characteristic from the polymer of application 20130309011. Furthermore, a water-absorbing polymer probably will not react well with salt water.

U.S. Pat. No. 8,512,552 by Rossi is an absorbent spill cleanup mat, but is different in concept from the present invention because the current invention takes advantage of the tendency of compressed wood pellets to expand, and absorb water, when they are in contact with water, and so a group of FLOODBAGs of the present invention can absorb water and expand to form a wall, when they are placed in contact with water. The invention of U.S. Pat. No. 8,512,552 is designed for different purposes.

Other inventions have discussed use of wood as a filler for sandbags, but, again, this is different from the compressed wood pellets of the present invention, because the compressed wood pellets have been compressed, which alters their characteristics including portability. The compressed wood pellets of the present invention can be transported more easily than non-compressed wood pellets, and can absorb water and expand when they are placed on site. Compressed wood pellets also expand much more than Earth does, when contacting water.

U.S. Pat. No. 4,650,368 by Bayer includes “inner bags” made out of paper that include microorganisms. The present invention's use of microorganism in remediation pouches is also not comparable to that in Bayer's invention, because microorganisms need to stay alive to be effective, and the biological arts are unpredictable, meaning that the way to keep the microorganisms alive in the remediation pouch of the present invention may be substantially different from Bayer's method. The remediation pouches of the current invention are also structurally different from the structures containing the microorganisms in Bayer, and the remediation pouches of the current invention are often made of paper that disintegrates in water, which is different from the material from which the structures containing the microorganisms is made in Bayer, and also the some of the specific types of microorganisms that can be used with the current invention are different from those listed in Bayer's patent. Bayer's invention includes water-absorbent material, but the water-absorbent material is made out of crushed paper, and does not have the additional characteristic that hydrocarbon molecules are kept out of parts of the invention that are designed to absorb water. The crushed paper of Bayer's invention can also only absorb a certain amount of water per unit weight. Bayer's patent also discloses the use of polypropylene sandbags, however, Bayer's patent does not seem to mention wood as a filler for sandbags at all. Bayer's invention also specifically claims a flood containment bag. The present invention can be used for dealing with smaller inundations besides flood containment. Crushed paper is chemically and structurally different from wood, compressed or otherwise. The present invention uses compressed wood pellets, that absorb water, as the main filling material for the FLOODBAGs. There is no reason to expect that paper would have the same absorption characteristics as wood, because the biological arts are unpredictable, and wood is a biological material.

Crushed paper also does not expand, when absorbing water, the same way that compressed wood expands when absorbing water. This is another advantage of the present invention over the prior art. Versions of the FLOODBAG of the present invention can be filled to less than 50% of its maximum capacity with compressed wood pellets, and then, when they encounter water, the water-absorbing pellets will absorb water and expand to a higher percentage of the capacity of the FLOODBAG (up to its maximum capacity).

U.S. Pat. No. 9,657,452 by Bailey discusses wood pulp as a sandbag filler, and also “cellulosic material”. However, the wood pulp is not “compressed”, and there is no evidence that one of Bailey's sandbags filled with wood pulp and cellulosic material would be lighter than a wet FLOODBAG of the present invention. A dry FLOODBAG of the present invention would also be much lighter than the same FLOODBAG, wet, because, when wet, the FLOODBAG would weigh much more because it would have absorbed water. The fact that compression of wood pellets structurally changes the wood within the wood pellets, makes the wood pellets qualitatively different from wood pulp, which has a different structure from the wood pellets. Also, the term “cellulosic material” is different from wood, because cellulose is one of the many compounds to be found within wood, and the combination and structure created by these different compounds is one of the reasons the wood is or was a living thing. Cellulose is a single compound and cellulose molecules, by themselves, are not the same structure as the living or formerly living cells and other structures comprising wood. Compressed wood is also compressed partially through eliminating the air spaces within the wood, which is a living or formerly living structure.

U.S. Pat. No. 7,841,268 by Bailey discusses the idea of polypropylene sandbags. Though absorbent fibrous material is discussed as a filler, no special characteristics about the fibrous material are listed. Wood pulp, as a type of fibrous material, is listed, but is not compressed. Crystalline polymers that absorb water are listed, but those are different from the wood pellets of the present invention.

A key point of difference between the FLOODBAGs of the present invention and the invention of U.S. Pat. No. 7,841,268 is that FLOODBAGs use compacted wood pellets, and in some versions of the FLOODBAG, the degree to which the wood pellets are compacted is defined: For example, in some embodiments the fact that the pellets are compacted to a certain percentage of their former weight and volume is important.

Wood pulp and compacted wood are different. The aim of pulping is to break down the wood into its constituent fibers, such as cellulose, thus disintegrating the internal structures of the wood. By contrast, compacting wood would leave traces of the internal structures of the wood. Modified versions of the internal structures would still be present in the pellets.

The idea of using a wood sandbag filler that weighs much less dry than wet is unique to the present invention.

Application 20020168227 by Rubin uses recycled carpet as the source of cellulosic material. It would not have been within ordinary skill in the art to use compressed wood as the filler, at the time of the invention of App. 20020168227. It would also not be obvious to one skilled in the art to create any of the later embodiments of the present invention because they all use compressed wood pellets as the absorption pellets. Some of them also use technologies that did not exist at the time of the invention of Application 20020168227.

The prior art references the examiner of Application 20020168227 cited, while rejecting that application, also use carpet as the source of sandbag filler.

The rejection of Application 20020168227 says that it would have been obvious through routine experimentation to determine the optimal core of the materials in the sandbag of Application 20020168227. One of the cited prior art patents in the final rejection of Application 20020168227 had ranges of “up to” a certain level for different components. These ranges were within the proportions listed for certain components of the filler in Application 20020168227. However, in the present invention, one of the salient features is compressed wood's ability to absorb water and keep larger molecules out. Compressed wood is not mentioned at all in Application 20020168227.

Notably, in Application 20020168227, even Claims 4, 17, and 18 were allowable if rewritten in independent form. Claim 17 was for creating a barrier of the bags of Rubin's invention, where recycled carpet material was the filler. Claim 18 involved putting the porous portion towards the liquid, and the nonporous portion away from the liquid. In other words, even though there were other inventions using cellulosic sandbag fill that already existed at the time of Rubin's invention, Rubin could still get a patent on some claims Likewise, all claims of the present invention should be patentable over Rubin because they all use compressed wood pellets as the fill, and use the weight of the bag when dry relative to the weight of the bag when wet as an important characteristic. Rubin does not have this characteristic, and none of the prior art inventions listed here have this characteristic.

In U.S. Pat. No. 9,297,134 by Dancer, an absorbent material is discussed, but the absorbent material seems to be unrelated to wood. Claim 8 says that the apparatus can use absorbent material and also a cellulosic material (meaning the absorbent material and cellulosic material are different things). Furthermore, in U.S. Pat. No. 9,297,134, the cellulosic material is never defined. Compressed wood, is a material with specific internal structures, different from “cellulosic material.”

In addition, in Dancer the absorbent material is clearly a component (not the main component) of a cellulosic fiber sheet. In other words, the main job of the cellulosic material in Dancer is not to be absorbent. It is to be a carrier for something else (sodium polyacrylate) that is absorbent.

Quickdam is one of Dancer's products product that uses sodium polyacrylate as a filler. The sodium polyacrylate is used as a filler for the Quickdams. This is, again, fundamentally different from the present invention, because sodium polyacrylate is chemically and structurally different from compressed wood. Sodium polyacrylate is also irritating to the eyes, so that if a dry Quickdam is punctured and sodium polyacrylate leaks out, the eyes of people nearby may become hurt or damaged. Compressed wood pellets do not irritate eyes.

Quickdams, using sodium polyacrylate, are also not for use with salt water (which will cause them to deflate because the polymer sodium polyacrylate will disintegrate), while FLOODBAGS use compressed wood pellets that can be used with salt water, and will not disintegrate in salt water.

The invention of U.S. Pat. No. 9,297,134 is also different from the present invention because it is structurally different. The type of barrier in U.S. Pat. No. 9,297,134 is shaped differently from a FLOODBAG and has different internal components. Dancer's invention works on different principles from our invention.

U.S. Pat. No. 7,258,904 by Watanabe appears to be using water-absorbent polymer, especially acrylonitrile, as a sandbag filler. Acrylonitrile and wood, compressed or otherwise, are different chemically, and there is no reason to expect that wood should have the same characteristics as a polymer, because the biological arts are unpredictable.

Application 20130309011 by Glodack discusses the concept of sandbag outer covers made of polypropylene. The sandbag is clearly filled with a water-absorbing polymer. A water-absorbing polymer and compressed wood are different things.

Application 20090103981 by Tagini includes a material suitable for absorbing the water and expanding when placed in contact with water, for enabling the passage of said device from an initial configuration wherein the volume of said device is minimal, to a swollen configuration, wherein the volume of said device is maximum. Paras. 33-36 make clear that the inventor is thinking of the water-absorbing material as being a polymer. This, again, is different from the present invention, where the use of a polymer as a water-absorbing material is not the emphasis. The present invention uses compressed wood as a water-absorbing material instead.

Application 20090321351, by Young, a bioremediation blanket, does not absorb water. It has an oleophilic component. It also has components for treating water by removing pollutants. This is different from the present invention, that absorbs water. The water-treating components of the invention of Application 20090321351 could not be easily modified to approximate the water-treating components of the current invention, because these water-treating components must remain outside where they can contact water that flows by, while, by contrast, the water-treating components of some embodiments of the present invention are inside the FLOODBAG, and disintegrate, releasing microorganisms, when sufficient water reaches them.

The present invention also uses fungi or fungal spores for bioremediation in some embodiments. This is different from the bacteria discussed in Young's invention. This also makes the present invention useful for applications for which Young's application cannot be used, because fungi can bioremediate some pollutants that bacteria cannot bioremediate. The use in the present invention of fungi, fungal spores, and bacteria different from those in Young is also not an “obvious” variation of the use of bacteria in Young's invention, because the biological arts are unpredictable, especially when involving the use of complete lifeforms for specific purposes. Therefore, the use of some bacteria in Young for bioremediation cannot make “obvious” the use of different bacteria, fungi, and spores for bioremediation using a different method in the present invention. It also cannot make obvious the use of any bacteria for bioremediation using a method different from Young's in the present invention.

Spores in general have the additional advantage that they require fewer nutrients than active organisms, therefore, versions of the present invention with bioremediation pouches that contain spores will not generally need a nutrient medium when not in use, while the bacteria in Young's invention will need a steady flow of nutrients when not in use for bioremediation. This makes the embodiments of the present invention that included bioremediation pouches easier to use in some ways than Young' invention.

U.S. Pat. No. 4,919,820 by Lafay uses duck feathers as the absorbent material. The main purpose of this invention is to clean up oil spills and petroleum-related spills. The duck feathers can be squeezed to remove the oil and reused. This is different from the present invention because the present invention uses compressed wood pellets as a material for absorbing water, and compressed wood pellets are a material with different characteristics from duck feathers. The biological arts are unpredictable, and similar biological materials can have very different characteristics.

Floodsax is a type of bag containing water-absorbing polymers, that expand when placed in water. This is substantially different from the present invention, though, because Floodsax's water-absorbing polymers, used to fill the Floodsax, are fundamentally different from the compressed wood pellets that are used to fill the FLOODBAGs of the present invention.

Floodsax is also expensive, costing $10 or more per bag. The compressed wood pellets of the present invention are also cheaper, per unit weight, than the water-absorbing polymers of the Floodsax invention. Water-absorbing polymers also generally disintegrate in salt water. Polymers and salt generally are incompatible.

The Ultra-aqua bag uses a super-absorbent polymer to absorb water, but this, again, is fundamentally different from the compressed wood pellets used to absorb water in the present invention. The “Safety Data Sheet” of the Ultra-aqua bag also says that the user should avoid release of the contents of the Ultra-aqua bag into the environment. The compressed wood pellets of the present invention are safe to release into the environment when dry, and are generally safe to release into the environment when wet (Unless they have been contaminated by hydrocarbons or some toxic compound).

Combining the references listed would not yield the invention of Claim 1 herein, because Claim 1 includes the water-absorbing pellets made of compressed wood. Use of compressed wood as a sandbag filler, because it absorbs water, is not a characteristic of any of the above inventions. Most of them use water-absorbing polymers, which are not the same thing as compressed wood.

Cellulose and compressed wood are different things. Cellulose is a specific compound that is a component of wood (mostly cell walls in wood) with a formula of (C₆H₁₀O₅)ₙ. Wood is or was a living thing with a lot of different chemical compounds. See, e.g. en.wikipedia/org/cellulose. Furthermore, different kinds of wood will have different chemical components, and different internal structure, including cells, phloem, xylem, and air spaces. A group of cellulose molecules, by themselves, would not have this structure, no matter how large the group of cellulose molecules. The internal structure of wood is important to its ability to absorb water after it has been compressed.

The FLOODBAG is effectively a sandless sandbag. Some embodiments of the FLOODBAGs of the present invention will be, when dry, 14 inches (35.56 cm), in width and 30-35 inches (76.2 cm-91.2 cm) in length. They will expand to about be about 6 inches (15.24 cm) in height when wet. Other embodiments of the FLOODBAGs can be of a variety of different sizes, and there is no real upper or lower limit to the size of a FLOODBAG. It is possible to build a version of the FLOODBAG that is 3 inches long, for example, or one that is 30 feet long or longer.

Many varieties of the FLOODBAG utilize a polypropylene outer shell with absorption holes, which is not a characteristic of most other inventions. Some other versions of the FLOODBAG use an outer shell made of burlap or a different substance. Many embodiments of the present invention also include specific additional components that absorb hydrocarbons and other substances deemed by specific users as “contaminants” for their purposes. Polypropylene is also capable of absorbing hydrocarbons. Many embodiments of the present invention therefore include a permeable hydrophobic outer shell. A polypropylene shell with absorption holes is one type of permeable hydrophobic outer shell.

The FLOODBAG has an additional advantage in that each FLOODBAG is cheaper than a comparable-dimensioned sandbag filled with a water-absorbing polymer. The FLOODBAG uses compressed wood pellets, which are cheaper per unit of volume, and per unit of weight, than water-absorbing polymers.

The compressed wood pellets are also much easier to dispose of than water-absorbing polymers, because the compressed wood pellets can be dumped into the environment to biodegrade, while a polymer might not be safe to dump.

The types of polymers used in prior art inventions are also generally irritating, if they come in contact with a person's eyes, or are ingested in relatively small quantities. A person must also be careful if he or she is near to a bag, containing one of these sandbags, where the bag is open. A person's eyes do not become irritated when they come in contact with compressed wood, wet or otherwise.

### Long-Felt but Unsolved Need

For as long as civilization has existed, humans have desired an easily deployable method of stopping sudden influxes of water, such as floods. Societies have long desired an easy method of flood control, and of limiting damage from problems such as spills of polluted water. As multistory buildings have become more common, a method of quickly containing sudden inundations of water within buildings, to avoid or reduce damage, has also become more important. Individual homeowners have also long needed an easy-to-deploy and rapid-acting, method of stopping a sudden inundation of water from reaching inside their homes. For example, an individual homeowner, watching a flood rise near his house, may need to place a mobile barrier in front of his door, to stop the flood from reaching inside, but the homeowner may not be able to access conventional sandbags, or another type of mobile barrier, in time to deploy the mobile barrier to stop the flood.

One problem with conventional sandbags is that they are heavy and hard to move, and to store on site, and to relocate if needed. Also delivering sandbags to a soggy area is a 3 person job if the sandbags can even be delivered at all to the soggy areas—A truck, driver, bag holder, shoveler, and possibly other personnel are needed to move the bags around, and stack them, onsite. In some cases, the truck and personnel may be unable to reach the place where the sandbags are needed, because of mud or other conditions that stop the truck and personnel from arriving at the place where the sandbags are needed.

Another advantage of the present invention is that the FLOODBAGs of the present invention can be easily moved and stored, unlike conventional sandbags, and so the FLOODBAGs of the present invention fulfill a long-felt but unsolved need for a mobile barrier defense, that can be easily stored and moved, and deployed when necessary, against sudden inundations of water. The FLOODBAGs of the present invention take up less volume, and weigh less, when dry, but expand their volume and weight when wet.

Deploying the FLOODBAGs of the present invention also involves lower labor costs than deploying conventional sandbags, and therefore fulfill another long-felt but unsolved need for a mobile barrier flood defense that is cheap to deploy, because the FLOODBAGs of the present invention are lighter and can be moved more easily. In theory, a group of students at a school could deploy a large number of the FLOODBAGs of the present invention quickly, to create a wall, to protect part of their school, in a class project. The students could take down any unused FLOODBAGs in another community project.

The present invention fills another long-felt, but unsolved need, because the FLOODBAGS bags of the present invention can function well, and absorb water and increase in size in fresh water, salt water, and brackish water, and sewer water. The FLOODBAGs of the present invention can be used in many different environments, and are very useful as defense against water inundations in areas where salted highways are used.

Prior inventions do not absorb salt water and brackish water, as well as regular water, and water-absorbing polymers will disintegrate when exposed to salt water. When encountering salt water or brackish water, the present invention has strong advantages over inventions that rely solely on water-absorbing polymers to absorb water. The FLOODBAGs of the present invention will gain weight, and so be more likely to stay in place, and serve as a barrier, when encountering such water, while, in a mobile barrier that relies solely on water-absorbing polymers to absorb water, the water-absorbing polymers will disintegrate if exposed to salt water, failing to absorb water and making the mobile barrier lighter, which means the mobile barrier more easily can be pushed aside.

With reference to phenomena such as the burst water mains in Los Angeles discussed above, the FLOODBAGs of the present invention are also highly useful because they can be deployed more quickly than regular sandbags. When the 96-year-old water main burst, the street was flooded, disrupting traffic and causing a traffic menace. The burst main also created a physical hazard to people in its vicinity, because two inches of water is enough to knock an adult off his or her feet, and maybe lead to drowning. Even though civic authorities quickly knew about the burst water main, they could not shut it off immediately for the reasons listed herein.

The present invention also fulfills another long-felt but unsolved need for a flood defense that a person living in a small house or apartment, with storage space at a premium, can store and use when needed, and then easily place back in storage if unused. A person living in an apartment or small house, or a business with storage space at a premium, can easily store the FLOODBAGs of the present invention and use them when needed, in a way that is not possible for conventional sandbags. For example, when a resident living in a small house is threatened with a sudden, large, rainstorm creating a flood that reaches near their front door, or their garage door, the resident can take several of the FLOODBAGs of the present invention, place them in lines in front of his or her front door and garage door, and then leave the house and come back later. The areas in danger from intrusions of water will therefore have a pre-positioned safety defense barrier. FLOODBAGs can be deployed when and where needed, and deployed much more rapidly than other mobile barriers. (If no water appears, the FLOODBAGS can be put back in storage in a closet!)

An apartment building property manager, or property manager for another type of real estate, can also store the FLOODBAGs of the present invention easily, and use them when needed, to deal with emergencies such as pipes breaking or spills in a laundry room. This substantially reduces the damage that the property will likely suffer from such emergencies. It may also lead to a reduction in insurance rates for the property.

The FLOODBAGs of the present invention are also easier to store, and move, than conventional sandbags, for individuals and entities with limited space; For example, an individual living in an apartment can store the FLOODBAGS of the present invention much more easily than conventional sandbags, which, by their nature are heavier and more difficult to move. A greater number of the FLOODBAGS of the present invention can be stored, in the same space, than conventional sandbags. (Floodbags in some versions of the first embodiment are only up to 2 inches high when dry).

The FLOODBAGs also are much easier to store, and use, for institutions such as schools, churches and other religious foundations, and universities, which may serve as community refuges during times of crisis (As many churches and other religious institutions served as community refuges during Hurricane Harvey in Houston). A school, church, or other religious foundation or university can easily distribute the FLOODBAGs to the community when needed, and also use the FLOODBAGs to defend its own premises from floods or other damage. For example, if parts of a school are threatened by rising water from a rainstorm, the staff and students can (with little risk of injury due to the light weight of FLOODBAGS) place a large number of the FLOODBAGs, in place, in a wall to stop the rising water, and then go back to their day.

In addition, during rainstorms, schools and universities sometimes find that parts of their premises are blocked by large puddles, and there is a long-felt but unsolved need for a fast, cheap method of stopping these problems. California State University Los Angeles (CSULA or Cal State L.A.), the inventor and writer's alma mater, has had this problem. In such a situation, a school or a university can easily deploy the FLOODBAGs of the present invention to prevent such puddles from blocking walkways and doorways, or to use two lines of such FLOODBAGs to create a clear path to a walkway or a doorway.

The present invention has the additional advantage that a large number of the FLOODBAGs of the present invention (generally at least 15) can be placed in a weatherproof plastic barrel, and carried around if needed, on a truck or other vehicle. A single person, driving the truck, can then use them to create mobile barriers quickly and efficiently, when needed. By comparison, the same number of conventional sandbags will take up much more space, and will weigh much more, than the FLOODBAGs of the present invention.

In addition, FLOODBAGs can be used to plug irregularly shaped holes in structures in structures, ships, and boats, because a FLOODBAG swells when exposed to water, and, when placed in a hole, can swell to a point where it can conform to the shape of the hole in the boat or other structure and therefore plugs that hole. A dry FLOODBAG can be put in an irregularly shaped hole in a boat or a dike, from either side, and the FLOODBAG would absorb water. A user can also add burlap to drape over the FLOODBAG(s) to further stabilize the barrier established by the FLOODBAGs.

The present invention solves many other long-felt and unsolved needs. One such need is a method, in certain areas such as Bangladesh, to prevent water containing bacteria or other germs, or storm water, from flooding into wells during and after a cyclone. This can lead to deaths from disease, and this phenomenon, in the past, led to many deaths from disease. A village or neighborhood can use the present invention to improve the defense of its wells from such phenomena. The people in the village or neighborhood can quickly move stacks of the FLOODBAGs of the present invention, which weigh less than conventional sandbags and require less time and effort to fill, to surround each well. Then, these FLOODBAGs will form a barrier that will impede water containing germs or other contamination, or storm water from flooding into the well.

The City and Lagoon of Venice, Italy are gradually sinking at a rate of 1-2 mm per year, and though large movable, floating gates are being constructed to protect the city and its Lagoon, it is not guaranteed that they will be successful, and the project will not be fully completed until 2022. Venice continues to suffer from “aqua alta” tides that flood parts of the city, and there is a long-felt (Since the Middle Ages) and unsolved need for property owners in Venice to have a defense against such inundations that can be quickly and easily deployed when needed. The present invention can help save Venice in the following manner: Residents and businesses in Venice can stockpile the FLOODBAGs of the present invention, and when a resident observes the water from an “aqua alta” tide, or other inundation of water, creeping closer to the resident's premises, the resident can quickly deploy the FLOODBAGs of the present invention to keep the water out of the premises. Venetian businesses can do the same, to keep inundations of water such as “aqua alta” tides out of their premises.

Water mains sometimes burst at unpredictable times, causing inundations of water, and government authorities may not have time to deploy sandbags and create mobile barriers before an inundation creates substantial and expensive damage. On Dec. 21, 2018, a 96-year-old water main ruptured in South Los Angeles. Fifty people were displaced, and the Los Angeles Department of Water and Power had to take four hours to shut off the water main because other pipes might have burst due to pressure in the system, if the water main was shut off immediately. A street was flooded, potentially damaging nearby residences and flooding the front lawns of several homes. At least 50 people were displaced from their homes and had to leave quickly. Another large pipe break released 10 million gallons of water near UCLA.

Large sections of the water pipe infrastructure of many cities are old, which raises the possibility of other large pipe breaks.

The present invention provides a defense for residents and others, who must quickly evacuate, to defend their possessions against water damage. A resident can easily store the FLOODBAGs of the present invention, and then when an inundation happens, such as an unexpected inundation caused by a water main bursting, or another cause, the resident can quickly place the FLOODBAGs in front of his or her doors and windows, and around items such as electronic components and computers, that may be particularly susceptible to water damage. The resident can then evacuate if needed.

Residents of places such as trailer parks, who are faced with inundations of water, whether caused by natural disasters, artificial problems such as water mains bursting, or caused by other reasons, also may wish to acquire FLOODBAGS ahead of time, and then, when a sudden inundation of water happens, a resident can deploy FLOODBAGs around the door to his or her trailer and/or around electronic equipment or anything else that is particularly vulnerable to water damage. The resident can then evacuate if needed. Alternatively, the central office of a trailer park may keep a supply of FLOODBAGs to distribute to residents if, and when, they are needed. Many trailer parks are also located in areas that are particularly vulnerable to damage from flooding. Trailers also usually have less extensive foundations than regular houses, and these foundations can be undermined by flooding. The present invention therefore can be used by trailer park residents to prevent the foundations of their dwellings from being undermined.

The present invention is also safe, and the wood pellets are environmentally degradable. This makes the FLOODBAGs of the present invention easier to store, for private persons, and easier to dispose of. The wood pellets can theoretically be thrown in the garbage after being used. The wood pellets can also be used for mulch in yards, forests, etc. The wood pellets are also not environmentally damaging when a FLOODBAG is in a dry and unused state, so FLOODBAGs containing the wood pellets can be stored without worry of environmental contamination.

FLOODBAGs can also be deployed by elderly, disabled, very young, and others much more easily than conventional sandbags, because a FLOODBAG weighs less than a conventional sandbag (6 pounds as opposed to approximately 30 pounds). An individual of even modest strength can utilize FLOODBAGs to make a barrier.

Conventional sandbags can also sometimes weigh much more than 30 pounds, because when a conventional sandbag is filled, the people filling it may fill the sandbag with wet sand, which weighs more than dry sand but takes up the same amount of space. This problem is absent with the FLOODBAGs, which are prefilled at the factory with wood pellets.

With conventional sandbags, overzealous or inexperienced personnel may put too much sand in a conventional sandbag. Wet sand is also more dense than dry sand. A sandbag filled with wet sand can have twice as much weight as a sandbag filled with an equivalent volume of dry sand. This is another reason that moving conventional sandbags can contribute to employee muscle aches, neck pain, etc., which is generally soft tissue damage, and employees requiring time off from work for soft tissue injuries. Repeatedly lifting approximately 30-60 pound sandbags results in more injuries, insurance claims and more litigation. The present invention avoids or substantially reduces this problem.

### SUMMARY OF THE INVENTION

### Term Numbers

The following term numbers shall apply to different components of the invention. (1) Outer shell. (2) Water-absorbing pellet. (3) Absorption hole. (4) oleophilic interior component. (5) Remediation pouch. (6) Tracking tag.

The outer shell includes an interior space therein. The outer shell completely surrounds the interior space, except for the absorption holes (3). The outer shell may be sealed together with heat fusion, adhesive, sewing, or other suitable fastening means, as one unit, but allowing liquids to penetrate into the interior space via the absorption holes. Among the other methods, listed herein, spring-ties, compression clamps, twisted wire, cable zip ties, twist-tie can be used to seal the outer shell together.

The outer shell will generally be sealed at the factory. If the FLOODBAG is produced at a remote site, for example, by transporting a machine to the remote site, and using the machine to produce FLOODBAGs, the outer shell can be sealed at the remote site, making the manufacturing process very flexible and simple.

In the first embodiment, the outer shell will be one polypropylene bag, open on one end, and components of the FLOODBAG including the water-absorbing pellets are placed inside. The opening is then sealed. The water-absorbing pellets are compressed wood pellets.

The water-absorbing pellets in all embodiments can also be made out of recycled wood, though this is not essential. The invention's use of recycled wood creates huge environmental benefits, because otherwise such recycled wood would probably be dumped in trash heaps or in landfills.

Wood pellets in all embodiments can serve as water-absorbing pellets if they are simply compressed, without additives being added to the wood pellets. This does not preclude the possibility of compressed wood pellets with additives being used as water-absorbing pellets.

In most other embodiments, the outer shell will be one bag, open on one end, and with components of the FLOODBAG, including the water-absorbing pellets, placed inside. The opening is then sealed.

The outer shell should be made of flexible or pliable material to maximize the utility of the invention.

The material of the outer shell, in the first embodiment, does not absorb water, but water flows into the interior of the FLOODBAG through the absorption holes in the outer shell when the FLOODBAG encounters water.

The outer shell is permeated by absorption holes, so that water can flow through the absorption holes and into the interior of the outer shell. The absorption holes should be smaller than the water-absorbing pellets in their dry state, so that the water-absorbing pellets stay inside the outer shell. The water-absorbing pellets expand when they absorb water, so they continue to stay inside the outer shell when they expand. The outer shell should also be made of a flexible material, so that when water penetrates the outer shell, the outer shell can expand. The FLOODBAG expands, within minutes, to the same general size and shape and weight as U.S. Army Corps of Engineers recommended conventional sandbags.

The absorption holes can be of different sizes in different embodiments of the invention, provided that they are small enough to prevent dry water-absorbing pellets from falling through the absorption holes. In some embodiments, the absorption holes can be too small to be seen with the naked eye, and still be effective, and in other embodiments, the absorption holes can be visible to the naked eye.

Sand leaks when casings holes enlarge even a little, in conventional sandbags. One of the unique points of our invention is that our invention utilizes holes in the outer covering to allow flood water to flow inside the FLOODBAG, which allows the water to contact the water-absorbing pellets within the outer shell. The water-absorbing pellets inside the outer shell would then absorb the water and not fall out of the outer shell, and this ability to absorb water is an advantage of the present invention over prior inventions. The pellets when dry are too large to escape through the holes, and when wet are swollen to an even larger size that precludes escape.

For purposes of this patent application, the “degree” to which wood pellets are compressed will be the ratio of the volume of the water-absorbing pellets after compression to their volume before compression.

The water-absorbing pellets absorb water when water flows through the absorption holes and contacts the water-absorbing pellets. The water-absorbing pellets gain weight as they absorb water, and the absorbed water also adds to the size of the water-absorbing pellets. This causes the outer shell to expand as the water-absorbing pellets contained within expand.

The fact that the FLOODBAGs of the first embodiment gain weight when the water-absorbing pellets absorb water is an advantage of this invention. The FLOODBAGs are lighter when dry, so that they are easier to transport, and to stack or otherwise build things from. Then, if the FLOODBAGs becomes wet, they gain weight which makes them harder to move, and more effective as a barrier, particularly when a large number of FLOODBAGs are stacked into a wall or other barrier. Also, at 6-7 pounds dry weight, FLOODBAGs can be pre-positioned in place with little fear of being moved by wind or footfalls from passersby, versus polymer bags that are so light weight they can easily be blown away.

Inside the outer shell in the first embodiment is also an oleophilic interior component, which absorbs oil and other hydrocarbon molecules that might move through the absorption holes. This also causes the outer shell to expand as the components inside the outer shell (The compressed wood pellets and the oleophilic interior component) absorb water and/or hydrocarbons. The oleophilic interior component can be one or more long polypropylene strips, which have the capacity to absorb hydrocarbons and heavy metal molecules. The oleophilic interior component can also have another form.

The wood pellets are smooth and have hard surfaces. This is a result of the process by which they are compressed. The smooth wood pellets can absorb water, but the wood pellets in the first embodiment are compacted to a point where they do not absorb significant quantities of oil or other hydrocarbons. Therefore, as the wood pellets absorb water and expand, the FLOODBAG will become bigger, but the wood pellets will not be significantly contaminated with hydrocarbons. This makes disposal of the wood pellets easier later.

In the first embodiment, the outer shell is made of polypropylene or some similar material. The outer shell generally has a “waxy” feel. The oleophilic interior component is also polypropylene. The polypropylene sheets used as the oleophilic interior component of some embodiments of the FLOODBAG appear similar to fabric such as cotton. Polypropylene is hydrophobic, therefore the material of the outer shell and oleophilic interior component do not normally absorb water when contacted by water. However, this will not have an impact on the ability of the pellets to expand and absorb water.

The compressed wood pellets, in the first embodiment, are compressed to substantially less in size than their prior volume, sometimes to between one fourth, and one fifth, of their prior volume, and the compression process also eliminates air spaces within the compressed pellets and causes the compressed wood pellets to have hard smooth sides, and for the space between the molecules within the compressed wood pellets to be small enough that larger hydrocarbon molecules cannot penetrate into the compressed wood pellets, while water molecules can get between the molecules in the wood pellets. As a result, the compressed wood pellets absorb water without absorbing hydrocarbons.

The oleophilic interior component in some versions of the first embodiment is a polypropylene mat. In other embodiments the oleophilic interior component may be something different. For example, it could also be a loose material that looks like cotton when shredded, or strips of polypropylene.

In the first embodiment, the compressed wood pellets may comprise at least 90% of the weight of the combined outer shell, water-absorbent pellets, and oleophilic interior component. This percentage can vary in other embodiments, as will be seen.

In the first embodiment, the wood pellets rapidly expand as they absorb water, increasing the size of the wood pellets. This causes the outer casing to expand. When the wood pellets have absorbed all the water they can absorb, the expanded volume of the wood chips causes the polypropylene outer shell to expand to the same approximate shape as a conventional sandbag filled with sand. The expansion of the compressed wood pellets drives expansion of the FLOODBAG. The expanded FLOODBAG will then be harder to move, because it will have gained weight, and its size restricts “topping” of it by flooding water. For greater barrier bulk, stacking the FLOODBAGS in a stack in pyramidal form is generally utilized.

The polypropylene outer shell includes multiple absorption holes, which allow liquid to flow into the bag and contact the wood pellets. When water contacts the wood pellets, these pellets absorb the water and expand. The process of compacting the wood pellets means that the pellets have smooth edges, which means that they do not absorb hydrocarbons.

In the first embodiment, the polypropylene outer casing and interior oleophilic component absorb hydrocarbon molecules that they encounter. Therefore, if there are stray hydrocarbon molecules in a water inundation that is encountered by the FLOODBAG, the outer casing and oleophilic interior component will absorb many of those hydrocarbon molecules.

In another embodiment of the invention, the top and bottom sides are mutually fastened.

In principal, the wood pellets, after they have served their flood barrier purpose, can be burned to create heat and light. The polypropylene outer shell of the first embodiment has a thermal value of more than 19,000 BTU per pound and cellulose, one of the main components of wood, has a BTU thermal value of 8,000 BTU per pound. Efficient methods of burning garbage to produce electrical power have been created (for example, in Copenhagen, garbage is burned to produce energy to artificially cool an artificial ski slope year-round), and these methods could be used to burn used FLOODBAGs to produce electricity as well.

### Using the Floodbags of the First Embodiment to Make a Barrier

The fact that the FLOODBAGs weigh less before they come into contact with water means that a crew of workers can utilize the FLOODBAGs in the following manner:

1. Place a large number of the FLOODBAGs in a wall formation, at a point which is threatened with an inundation. The FLOODBAGs will be comparatively easy to place, because at this point, the FLOODBAGs have dry, compressed, wood pellets as their filler. They will therefore weigh much less than conventional sandbags.
2. When the inundation arrives, the FLOODBAGs will absorb water and become heavier. The FLOODBAGs will therefore be less likely to be dislodged, and provide more protection against the inundation. The first embodiment of the current invention relies on the tendency of the wood chips to expand and weigh more, after they have been exposed to water, to create better defense against inundations.

Two formations in which FLOODBAGs can be stacked (Not the only two) are A. A “pyramidal” formation, and B. Stacked one on top of the other in a wall.

A dry FLOODBAG of the first embodiment weighs as little as ⅕-⅙ as much as a conventional sandbag, so a crew can add 5-6 FLOODDBAGs for each conventional sandbag by weight as flood defense. In areas with fire damage, muddy roads, and/or steep terrain, or where a hillside needs to be protected, this weight difference becomes even more important, because it means that FLOODBAGs can be deployed and reused in such situations more easily than conventional sandbags.

The weight of the FLOODBAGs also gives the following advantage: The FLOODBAGs are much lighter than conventional sandbags, but are heavy enough that, when stacked, they will not be easily disturbed by things like wind, and vibrations from vehicles or people walking nearby.

More than two FLOODBAGs also can be theoretically carried easily in a backpack by an individual. By contrast, conventional sandbags that comply with U.S. Army Corps of Engineers standards will likely weigh approximately 30 pounds or more, and more than two conventional sandbags cannot practically be carried, especially uphill or over difficult terrain, in a backpack by an individual. This also makes deployment of the FLOODBAGs much easier.

FLOODBAGs are overall less labor and time intensive than conventional sandbags.

### Disposing of the Wood Pellets

When the wood pellets have absorbed water up to their maximum capacity, they will usually, in the first embodiment, turn to sawdust-like material or wood chips.

The wood pellets, that have absorbed water, are relatively easy to dispose of, if desired. They are also biodegradable, and can essentially be dumped, or spread out on the ground to go back into the ecosystem, effectively as mulch. Federal and most state and local regulations may allow the wood pellets to be so disposed of.

The wood pellets that have absorbed water, can also theoretically be used for other purposes, for example, they can be used as mulch, or as a medium for mushrooms. The wood pellets, and the casings and polypropylene oil mats can also theoretically be burned for light or heat. They can be used as compost, as well, or potentially for paper. This assumes that the wood pellets have not absorbed any substantial amounts of toxins along with the water.

This is another superiority of the present invention over sandbags, because sand is not biodegradable, and has few other uses, and can settle in drains, street gutters, creeks, and other natural watercourses, and clog them. The present invention is potentially more environmentally beneficial than sandbags because of the way that the wood pellets can be turned into mulch, and for other reasons.

The polypropylene casing used in the first embodiment is not biodegradable, however, most of the weight of each dry or wet FLOODBAG of the first embodiment is comprised of the wood pellets.

The first embodiment of the invention should not preferably be used as a “first-line” defense against a hydrocarbon spill such as an oil spill. Depending on the degree of compression and other factors, other embodiments of the FLOODBAGs could be used as a first-line defense against a hydrocarbon spill.

The first embodiment of the invention can be placed easily on a shipping palette, with multiple FLOODBAGs placed in one plastic lined bag, or shipped in other ways. An organization such as a shopping mall, school, or large factory can theoretically strategically place relatively compact waterproof barrels, each containing at least 15 dry FLOODBAGs, at numerous locations on its premises, for maintenance personnel to quickly open the barrels and deploy the FLOODBAGs if needed. As mentioned elsewhere in this application, an individual can purchase FLOODBAGs if they are needed, and then store them in a dry place until they are needed.

### Some Additional Potential Uses of the First Embodiment of the Present Invention

The invention can easily be purchased by individuals, and stored in a safe place for a “rainy day”. The invention may be used by individuals who are worried that a potential rainstorm or other emergency might damage their property. The individual can quickly place the “FLOODBAGs” in places that he or she thinks will be in danger from water, and then leave the premises. A user could theoretically then go to work, a social event, a movie, etc., then return, and if there is no water damage, could put the FLOODBAGs away until they are needed later. This flexibility also helps users to save their own lives, by allowing users to protect their possessions quickly from intrusions of water, and then leave the premises and the danger created by these intrusions.

If a user knows that an emergency such as a storm will soon arrive, the user can also sometimes order the FLOODBAGs from Amazon.com or another service, and have the FLOODBAGs delivered to e user in a day.

A user could also create a harrier out of FLOODBAGs even if he or she does not fear an imminent intrusion of water, but wants to prepare in case one happens in the future. For example, a user could deploy the FLOODBAGs around an aquarium just in case the aquarium springs a leak. In addition, the user could use FLOODBAGs to create a barrier between a bathroom or kitchen or atrium and the rest of the house.

A user could also use FLOODBAGs to guard against intrusions of water in an area that the user does not plan to monitor often. For example, a user who owns a storage unit can place FLOODBAGs near the entrance to the storage unit, to guard against intrusions of water that might happen while the user is gone, even if the user does not believe that such intrusions of water will happen. The user may not return to the storage unit for months, but in the meantime, the FLOODBAGs will guard against any intrusion of water, through the entrance to the storage unit, that might happen.

A user who thinks that parts of his or her premises could be in danger from water damage could deploy the FLOODBAGs in areas that might potentially be in danger from water damage (such as a basement) and then go on vacation. If water contacts the FLOODBAG, that water will be absorbed by the compressed wood pellets therein. The areas in danger from water will therefore be safer, The FLOODBAGs are lighter than conventional sandbags, but usually weigh at least 6 pounds, when dry, which is heavy enough to resist movement by wind, foot falls, etc. The FLOODBAG can absorb water, when it contacts fresh water, salt water, sewer water or brackish water. This is a substantial superiority of the FLOODBAG over most competing inventions, because most competing inventions do not absorb salt or brackish water. The FLOODBAGS can also be used to stop an inundation of brackish water that might come from a marshland.

An organization such as the U.S. Army or other branches of the military, that sometimes must prepare camps and bases quickly, and also must sometimes engage in disaster relief for the civilian population in the event of an unexpected inundation can also use the FLOODBAGs of the present invention to quickly set up defenses against water damage caused by a flood, or a large rainstorm, or another inundation of water, by placing the FLOODBAGs of the present invention around areas and objects that need to be protected from inundations of water.

The U.S. military must often use scarce shipping resources to ship supplies to distant areas of the world, and FLOODBAGs are much easier to ship than conventional sandbags, because they are lighter than conventional sandbags when dry, and creating a barrier out of FLOODBAGs is less labor intensive than creating a barrier out of an equivalent number of conventional sandbags. These are two advantages of FLOODBAGs from the point of view of the Army, Marines, Navy, Air Force, or Coast Guard.

The U.S. military must also sometimes deliver aid to civilians in territory that has been devastated by war or for other reasons (Such as the aid that was sent to victims of the Indian Ocean Tsunami of 2004). FLOODBAGS can potentially be an important part of this aid, to help civilians, for the reasons mentioned above, and for other reasons.

One example of a situation where FLOODBAGs might have been useful to the U.S. military is Typhoon Louise, which veered unexpectedly north and hit Okinawa on Oct. 9-10, 1945, and then hit Japan as a strong tropical storm on or about Oct. 12, 1945. The typhoon damaged many of the temporary structures the U.S. military had built at its temporary base at Buckner Bay, and also damaged at least 60 aircraft and other equipment. If the U.S. military had FLOODBAGs available, during Typhoon Louise, some of this equipment, and some more lives might have been saved in Okinawa. In addition, FLOODBAGs could have been flown to Japan (World War II had recently ended) to create mobile barriers and limit the damage from Typhoon Louise there.

The present invention also frees up military personnel who might otherwise be tasked with building sandbag walls. For example, when camping in the field, military personnel must build walls composed of conventional sandbags around their tents if there is a chance of rain. The present invention allows military personnel to much more quickly build barriers composed of 6-pound FLOODBAGs and then, if the FLOODBAGs are not wet, to take down the barrier, carry the FLOODBAGs to the next camp location, and use them there.

In all of the above situations, barriers made of FLOODBAGs can also be used to channel water or pool water.

All agencies of the government, and military should stockpile FLOODBAGs for use in emergencies, or to distribute to civilians if needed.

A government of an island or other location where help may need to be airlifted in after a disaster should also stockpile FLOODBAGs.

FLOODBAGs have a Logistical and deployment advantage over conventional sandbags because a dry, unused FLOODBAG is much lighter than a conventional sandbag. FLOODBAGs can be airlifted in, when needed, or dropped from airplanes or helicopters, and civilians can simply grab them and run take them to a place where they are needed.

FLOODBAGs can also be transported to a point where they are needed much more easily than conventional sandbags. As an example, a truck capable of carrying one ton can carry about 350 FLOODBAGs of the first embodiment, vs. 60 conventional sandbags. Furthermore, once the FLOODBAGs arrive at their destination, the truck driver can go into the back of the truck and throw or carry out the FLOODBAGs. By contrast, 60 conventional sandbags will require a crew of more than one additional person to take the sandbags off of the truck in the same length of time.

### Additional Embodiments of the Invention

### The Second Embodiment

The second embodiment of the invention uses a stiffener, inserted into each FLOODBAG. The stiffener might simply be an elongated, light object, or another object, placed inside the FLOODBAG. The stiffener might help the FLOODBAG keep a desired shape, because the outer shell will not be able to easily change its shape in a way that changes the shape of the stiffener. The stiffeners can be long plastic strips, or may have another configuration.

### The Third Embodiment

The third embodiment of the invention uses one or more tracking chips for each FLOODBAG. The chip may be an RFID or M2M chip, or any other type of chip known to the prior art, and may be embedded in the outer shell, or elsewhere. The chips embedded in the FLOODBAGs create broadcasts, and the broadcasts are relayed to a tracking station, which can determine the location of each FLOODBAG from the broadcasts.

For example, a large number of FLOODBAGs, with tracking chips, can be placed together to form a wall. All of the tracking chips will broadcast signals that will be received by nearby listening units such as wireless routers and relayed, potentially over the internet, to a tracking station. If one of the FLOODBAG is moved out of position, by force of water pushing against it, or for another reason, the tracking station will detect that, from the absolute and relative locations of the tracking chips that one of the FLOODBAGs has been moved out of position, relative to the others, and that there is probably a “breach” in the barrier created by the FLOODBAGs. The tracking station will then send an alarm, so that appropriate personnel become aware that a breach has probably happened, and investigate and close the breach.

If FLOODBAGs are being used to plug holes in a dike or dam, and are equipped with tracking chips, a tracking station will detect if one of the FLOODBAGs has been moved out of its absolute or relative location, relative to the others, which would indicate a breach in the dam or dike. The tracking station will then send an alarm in the manner discussed above.

### The Fourth Embodiment

In the fourth embodiment of the invention, each FLOODBAG includes a glow-in the dark marking on its outer shell. The glow-in-the-dark marking may be placed over all, or a part of, the outer shell. This glow-in-the dark marking makes the FLOODBAG easier to see and move at night, or at other times when light is not available. Any kind of glow-in-the dark mark will fulfill the requirements of this embodiment.

### The Fifth Embodiment

In the fifth embodiment, each FLOODBAG has a grommet, and a fastener which can be placed through another grommet, on its outer surface. This will help multiple FLOODBAGs to be connected together via the fastener of each FLOODBAG being connected to the grommet of another FLOODBAG, when the FLOODBAGs are used to form a mobile barrier.

### The Sixth Embodiment

In the sixth embodiment, each FLOODBAG has at least one zip-tie on its outer surface. The FLOODBAGS can be tied together without breaking the outer surface of any FLOODBAG. This will help multiple FLOODBAGs to be connected together via the zip-ties of the FLOODBAGs being connected together, when the FLOODBAGs are used to form a mobile barrier.

### The Seventh Embodiment

In the seventh embodiment, each FLOODBAG will have multiple interior compartments. Each interior compartment can hold a separate remediation pouch or another component such as the spill cleanup mat of U.S. Pat. No. 8,512,552.

### The Eighth Embodiment

The eighth embodiment will include at least one “remediation pouch” (5) that contains an agent that has the ability to clean up one or more pollutants, generally by absorbing or bonding with the pollutants. The remediation pouch(es) will be inside the outer covering, along with the water-absorbing pellets. The remediation pouch(es) can be made of some material that disintegrates in water, such as paper. Therefore, when an inundation of water reaches the FLOODBAG, the remediation pouch wall will disintegrate and the agent will be released to absorb or bond with the pollutant.

A FLOODBAG can contain multiple remediation pouches, some of which contain different agents, to be able to deal with water that is contaminated with multiple pollutants.

There is sometimes a danger from an inundation of polluted water, where the pollutants will be carried by the water and will contaminate the areas that are inundated by the water. This embodiment of the FLOODBAG helps to neutralize the pollutants, stopping them from contaminating other areas.

This embodiment can be especially useful for stopping or partially or fully blocking an inundation of polluted water. For example, a gold-mining company can deploy a large number of FLOODBAGS with remediation pouches containing a metal or other chemical agent that binds with cyanide, in a wall, next to a cyanide extraction pond, to be prepared for the possibility that cyanide-contaminated water floods out of the cyanide extraction pond. If cyanide-contaminated water does flood out of the pond, it will reach the FLOODBAGs, the walls of the remediation pouches will disintegrate, and the metal inside them will be released to hopefully bind with the cyanide, so that the cyanide does not poison wildlife.

Some examples of chemical agents that will bond with pollutants are chelating agents such as EDTA. EDTA will bind with lead, and the combined product will precipitate out of water solution. Therefore, a user that fears an inundation of water that includes lead can deploy FLOODBAGs with remediation pouches containing EDTA in a wall between the contaminated water and the area of ground that the user fears will be inundated. If the contaminated water reaches the wall of FLOODBAGs, the walls of the remediation pouches will disintegrate, and the EDTA will be released into the water, to hopefully bind to the lead molecules and cause the combined lead-EDTA complex to precipitate out of the water.

FLOODBAGs with remediation pouches containing other types of chemical agents are possible.

Remediation pouches can also contain organisms, such as microorganisms, that can neutralize specific pollutants by processing them, binding with them, or absorbing them. These organisms fall under the definition of “agents” in this patent application. Bacteria and Fungi that aid in bioremediation are two examples of these organisms. These remediation pouches can aid in bioremediation and biodegradation, bioaugmentation and biostimulation.

Some bacteria that can be placed in the remediation pouches include Pseudomonas Putida. Pseudomonas putida is a gram-negative soil bacterium that is involved in the bioremediation of toluene, a component of paint thinner. It is also capable of degrading naphthalene, a product of petroleum refining, in contaminated soils.

Dechloromonas aromatica can also be placed in the remediation pouches, and is a rod-shaped bacterium which can oxidize aromatics including benzoate, chlorobenzoate, and toluene, coupling the reaction with the reduction of oxygen, chlorate, or nitrate. It is the only organism able to oxidize benzene anaerobically. Due to the high propensity of benzene contamination, especially in ground and surface water, D. aromatic is especially useful for in situ bioremediation of this substance.

Deinococcus radiodurans, which can also be placed in the remediation pouches, is a radiation-resistant extremophile bacterium that is genetically engineered for the bioremediation of solvents and heavy metals. An engineered strain of Deinococcus radiodurans has been shown to degrade ionic mercury and toluene in radioactive mixed waste environments.

FLOODBAGS, each containing two remediation pouches, one containing bacteria that will oxidize ammonium to nitrite, and a second remediation pouch containing bacteria that will oxidize nitrite to nitrate, can also be used to remove unwanted nitrogen compounds. Industrial bioremediation is used to clean wastewater. Most treatment systems rely on microbial activity to remove unwanted mineral nitrogen compounds (i.e. ammonia, nitrite, nitrate). The removal of nitrogen is a two stage process that involves nitrification and denitrification. During nitrification, ammonium is oxidized to nitrite by organisms like Nitrosomonas europaea. Then, nitrite is further oxidized to nitrate by microbes like Nitrobacter hamburgensis.

In anaerobic conditions, nitrate produced during ammonium oxidation is used as a terminal electron acceptor by microbes like Paracoccus denitrificans. The result is N₂ gas. Through this process, ammonium and nitrate, two pollutants responsible for eutrophication in natural waters, are remediated.

Other remediation pouches can contain agents designed to bind with Zinc and other heavy metals, and remove them from water.

A remediation pouch can also contain seeds, so that if the FLOODBAG with the remediation pouch is later used as mulch, the seeds may germinate and grow into plants.

Methylibium petroleiphilum (formally known as PM1 strain) is a bacterium capable of MTBE bioremediation, and PM1 can be used in remediation pouches. PM1 degrades MTBE by using the contaminant as the sole carbon and energy source.

Alcanivorax borkumensis, which can also be used in remediation pouches, is a marine rod-shaped bacterium which consumes hydrocarbons, such as the ones found in fuel, and produces carbon dioxide. It grows rapidly in environments damaged by oil, and has been used to aid in cleaning the more than 830,000 gallons of oil from the Deepwater Horizon Oil Spill in the Gulf of Mexico.

Spores of fungi, including, but not limited to, P. chrysosporium, can also be used in remediation pouches. P. chrysosporium was the first fungi linked to degradation of organic pollutants. Extensive research has show this it has strong potential for bioremediation in pesticides, PAHs, dioxins, carbon tetrachloride, and many other pollutants. However, fungi are effective at PAH degradation in comparison to bacteria for a few reasons. Firstly, they are capable degrading PAH's that are high in molecular weight, bacteria in comparison are better at degrading smaller molecules. Secondly, fungi can function well in non-aqueous environments and low oxygen conditions, both are conditions where PAH's can accumulate. For example, fungi are useful in situations where contaminants are physically blockaded and bacteria cannot reach or in circumstances of environmental extremes such as high acidity or dryness prevent bacteria from functioning.

Some remediation pouches can also include a nutrient medium inside the remediation pouch, which will allow any lifeforms inside the remediation pouch, that require nutrition to survive, to receive such nutrition.

It is important to note that some lifeforms, such as many spores of fungi, or of bacteria, require little or no nutrition until they germinate and start to grow. Therefore, remediation pouches containing spores of fungi, for example, would often not need such a nutrient medium.

According to the EPA, at one contaminated site, the Southern California Edison Visalia Pole Yard, in California, the cleanup included construction of a slurry wall around the contaminated area. FLOODBAGS of the present type would be a useful addition to such a slurry wall, to reduce the possibility of more land being contaminated later.

### The Ninth Embodiment

The ninth embodiment of the invention involves each FLOODBAG having more than one of the components listed in each of the other embodiments. For example, each FLOODBAG may have a glow-in-the-dark marking, and a radio tag, and a remediation pouch inside the FLOODBAG.

Variations of the FLOODBAG can be created, with any combination of the components from different embodiments that is desired by the user. The component mix can be switched whichever way the user needs them to be.

### The Tenth Embodiment

The tenth embodiment will have an outer covering, composed of a different substance besides Polypropylene. For example, the outer covering can be composed of burlap or another substance. The outer covering will include absorption holes, and the water-absorbing pellets will be larger, when dry, than the absorption holes.

### The Eleventh Embodiment

The embodiment can have Velcro patches, or patches using another type of “hook-and-loop” fastener, on each FLOODBAG. The Velcro patches are at specific locations on the FLOODBAG, and each FLOODBAG will have Velcro “hook sections”, and Velcro “Loop sections” in locations so that the FLOODBAGs can be stacked, with the “hook sections” on one Floodbag placed next to the “loop sections” on another FLOODBAG.

### The Twelfth Embodiment

The twelfth embodiment includes an outer covering, with absorption holes, and also water-absorbing pellets in the interior of the outer covering, but will not include an oleophilic interior component.

### The Thirteenth Embodiment

The thirteenth embodiment utilizes a rough-to-the touch medallion of the type disclosed in application Ser. No. 14/617,355, which is adhered to each FLOODBAG. This rough-to-the-touch medallion includes a QR code that tells the types of components inside the FLOODBAGs in the batch from which that FLOODBAG came. Examples are whether the FLOODBAGs in that batch included a mix of wood pellets with different absorption capacities, and what pellets were in the mix, and whether the FLOODBAGs in that batch included remediation pouches, and what was in the remediation pouches.

### The Fourteenth Embodiment

The fourteenth embodiment of the invention involves an oleophilic interior component comprised of a paper-like polymer, that is be placed inside the outer shell. In some versions, the oleophilic interior component can be a flat surface, which will allow the apparatus to be laid flat more easily, when necessary.

The oleophilic interior component should also be comprised of a type of polymer that absorbs hydrocarbons, or of a combination of such a polymer and other material.

### Use as a Mouse Pad

The fourteenth embodiment of the invention could potentially be used as a mouse pad, that can absorb spills on a desk, where in the following manner: A version of the apparatus including a stiffener attached to one part of the interior wall of the outer shell can be placed on the desk. The stiffener would force the part of the outer shell attached to the stiffener to conform to the stiffener's shape. The stiffener should preferably be large enough that the part of the outer shell attached to the stiffener will be a flat surface. Then, the user can place the apparatus on a desk, and place the mouse on the outer part of the wall of the outer shell where the stiffener is attached to the interior wall. The user can then move the mouse along the apparatus and use the apparatus as the mouse pad. The mouse's tracking systems will monitor this movement. If a water spill happens on the desk, the water-absorbing pellets (3) inside the apparatus will absorb the water.

Additionally, an oleophilic interior component can be placed inside the outer shell, either in addition to, or in place of, the stiffener previously mentioned. The oleophilic interior component can also be attached to the interior wall of the outer shell.

The stiffener, or oleophilic interior component, does not need to be attached to the interior wall of the outer shell, but the apparatus will probably function better as a mouse pad when the stiffener or oleophilic interior component will is attached to the interior wall of the outer shell.

An apparatus of one of these types can also be used as a mouse pad on another type of surface besides a desk.

### The Processes

All embodiments are useful for placement in front of a street storm drain (not shown), for example, where petrochemical-laden or otherwise contaminated water run-off from the street is first cleaned through the mat before entering the storm drain.

Most versions of the first embodiment of the invention uses compressed pine pellets, but other types of wood may be useful, for the compressed wood—Some types of wood work better than others for this purpose.

The process of using each of the embodiments of the invention, to defend against an inundation or intrusion of water, is explicitly part of the present invention.

### Other Embodiments

In other embodiments, including other versions of all the embodiments discussed above, the place of the water-absorbing pellets in the interior of the FLOODBAG would be taken by a combination of water-absorbing pellets (2) and a quantity of one or more types of water-absorbing polymers. This allows both the water-absorbing pellets (2) and the water-absorbing polymer to absorb water. The combination may include a mixture of primarily water-absorbing pellets (2) by weight with a smaller amount of the polymer(s), or the quantity of water-absorbing pellets in the FLOODBAG might weigh as much as the combined quantity of all the water-absorbing polymers, or the FLOODBAG might contain a higher quantity by weight of water-absorbing polymers, and a lower quantity by weight of water-absorbing pellets (2). This configuration may be particularly useful in certain situations (See the section of this application entitled “A method of creating FLOODBAGs to math each particular emergency).

Another version of this embodiment involves, inside the interior space, a combination of compressed wood pellets, and a water-absorbing polymer that is biodegradable and harmless to wildlife and humans. The compressed wood pellets will absorb salt, sewer, or fresh water, that is encountered by the apparatus. The water-absorbing polymer will absorb sewer and fresh water.

Some versions of this embodiment may also involve an oleophilic interior component that absorbs hydrocarbons.

Imbiberbeads, discussed at Imbiberbeads.com, are one example of this oleophilic interior component. Imbiber beads are a super-absorbent polymer that meets ASTM International Standards and can absorb a very broad cross-section of the organic chemical spectrum. The Imbiberbeads grow as they absorb hydrocarbons. Imbiberbeads do not appear to be able to absorb water, and are hydrophobic.

Some embodiments of the invention can use Imbiberbeads as an oleophilic interior component. In these embodiments, the water-absorbing pellets will swell as they absorb water, and the Imbiberbeads will swell as they absorb any hydrocarbons.

### Types of Wood that can be Used to Create the Water-Absorbing Pellets

The inventor has found that compacted pine wood pellets fulfill the function of the water-absorbing pellets very well, but other types of wood pellets can also be compacted and used for this purpose. Not all types of wood perform equally well for this purpose, however. Different degrees of compaction and the process by which they are compacted make a difference to the wood's ability to absorb water while rejecting oil and other larger molecules. In general, compacted softer woods fulfill the function of the pellets better than compacted harder woods.

The compaction process also causes release of molecules in each of the wood pellets that holds that wood pellet together, in a manner loosely analogous to glue.

The absorption capacity of wood can also be affected by seasonality, however, compressed pine wood pellets will consistently absorb water.

### A Method of Creating Floodbags to Match Each Particular Emergency

The following variables can be customized for each “batch” of FLOODBAGs, depending on the circumstances and the needs of the user.

1. The amount to which the wood pellets inside the FLOODBAG are compacted.
2. The nature and contents of the remediation pouches included in this this particular batch.
3. The needs of this particular user in terms of whether the user needs to monitor the exact location of the FLOODBAGs to determine whether a breach in a barrier has happened.
4. The type of wood pellets inside the FLOODBAG.
5. The type and shape of oleophilic interior component inside the FLOODBAG.

By controlling the degree to which the wood pellets are compacted, and by varying the types of other components in each “batch” of FLOODBAGs of the present invention, users can create FLOODBAGs tailored to a specific emergency.

The degree to which the wood pellets are compacted affects their ability to absorb molecules larger than water molecules (H₂O). The less they are compacted, the greater their ability to absorb molecules larger than water. Some users might desire FLOODBAGS where the wood pellets can absorb larger molecules for a specific use. A user can therefore create or request a batch of FLOODBAGs that have wood pellets that are less compacted than those in the first embodiment.

Wood pellets that are compacted less than those in the first embodiment can absorb some hydrocarbon molecules and other larger molecules. Their ability to absorb such molecules is negatively related to the degree to which they are compacted, for example, wood pellets that are compacted less will be able to absorb more hydrocarbon and other large molecules.

Therefore, a user desiring to create a batch of FLOODBAG to deal with a specific situation, where it is necessary for the wood pellets to absorb larger molecules can compact the wood pellets less than they would be compacted in the first embodiment. If the wood pellets are compacted less, they will absorb more hydrocarbons and larger molecules.

Each FLOODBAG can include multiple remediation pouches, and the number of remediation pouches, and contents of each of the remediation pouches for each FLOODBAG in each batch of FLOODBAGS can be customized, fora specific user, to optimize that FLOODBAG batch's ability to stop and clean up an inundation with specific characteristics.

The design of the FLOODBAG of each embodiment also allows a user to modify the construction of a particular batch of FLOODBAG of the present invention by, when manufacturing the FLOODBAG of the present invention, adding steps to the manufacturing process.

For example, a user can specify the contents of a specific batch of FLOODBAGs for a specific application, and then then the FLOODBAG can be manufactured through an assembly line. A user can request inclusion of a blend of wood pellets with different compaction profiles, in the same FLOODBAG, to meet different needs. The different types of wood pellets can be blended in a mixer, and then appropriate quantity of the mixed pellets can be placed in each FLOODBAG.

Each FLOODBAG can include multiple remediation pouches, and the number of remediation pouches, and contents of each of the remediation pouches for each FLOODBAG in each batch of FLOODBAGS can be customized, for a specific user, to optimize that FLOODBAG batch's ability to stop and clean up an inundation with specific characteristics.

### Use with Rossi's Spill Cleanup Mat Invention

The FLOODBAG of the present invention can also be used together with Thomas R. Rossi's invention of U.S. Pat. No. 8,512,552, which is a spill cleanup mat, which can be used for hydrocarbon spills, watery spills, and other spills.

One way in which the FLOODBAG can be used with the invention of U.S. Pat. No. 8,512,552 is that each FLOODBAG can contain an example of the spill cleanup mat of U.S. Pat. No. 8,512,552 (Hereafter spill cleanup mat), in addition to the compressed wood pellets. When the FLOODBAG is deployed, liquid that reaches the absorption holes can penetrate through the FLOODBAG to the spill cleanup mat. The spill cleanup mat can then absorb chemicals in the liquid, according to the characteristics of the spill cleanup mat.

A second method involves adhering a spill cleanup mat to the exterior of each FLOODBAG. The two items can then be placed in the same location to guard against inundations of water. A wall or barrier of the FLOODBAGs, each with a spill cleanup mat adhered to it, can be built, in anticipation of an inundation of water, or another liquid, and then the FLOODBAGS and spill cleanup mats will both fulfill their intended functions if an inundation comes.

The discussion included in this patent is intended to serve as a basic description. The reader should be aware that the specific discussion may not explicitly describe all embodiments possible, and alternatives are implicit, or obvious to those skilled in the art. Also, this discussion may not fully explain the generic nature of the invention and may not explicitly show how each feature or element can actually represent equivalent elements. Again, these are implicitly included in this disclosure. Where the invention is described in device-oriented terminology, each element of the device implicitly performs a function. It should also be understood that a variety of changes may be made to the embodiments that have been described, without departing from the essence of the invention. Such changes are implicitly included in the description. These changes still fall within the scope of this invention.

Furthermore, each of the various elements of the invention and claims may also be achieved in a variety of manners. This disclosure should be understood to encompass each such variation, whether it is a variation of an apparatus embodiment, a method embodiment, or a variation in any element of an embodiment. As the disclosure relates to elements of the invention, the words describing each element may be replaced by equivalent apparatus terms, even if only the function or result is the same. Such equivalent, broader, or even more generic terms should be considered to be encompassed in the description of each element or action. Such terms can be substituted, when desired, to make explicit the implicitly broad coverage to which this invention is entitled. It should be understood that all actions may be expressed as a means for taking the action in question, or may be expressed as an element for causing the action in question. Similarly, each physical element disclosed should be understood to encompass a disclosure of the action which that physical element facilitates. Such changes and terms are to be understood to be explicitly included in the description.

### BRIEF DESCRIPTION OF THE DRAWINGS

FIG. 1 shows one of the “FLOODBAGs” of the first embodiment of the present invention, while in the “dry” state, and laid flat. The absorption holes (3) are visible in the outer casing.

FIG. 2 shows one of the “FLOODBAGs” of the first embodiment of the present invention, with water having been absorbed into the compressed wood pellets in the FLOODBAG. Oil is not absorbed into the wood pellets, because they are smooth and, because they are highly compacted, the hydrocarbons cannot penetrate the wood pellets.

FIG. 3 is a cut-away view of one of the “FLOODBAGs” of the present invention.

FIG. 4 is a stack of the FLOODBAGs of the first embodiment of the invention, on a truck ready for transport;

FIG. 5 is a group of FLOODBAGs of the invention, in a wall formation, in position to stop an ongoing spill of water.

FIG. 6 is a group of FLOODBAGs of the present invention, with tracking chips, stacked in a vertical wall and broadcasting. The broadcast is relayed to a tracking station. One of the FLOODBAGs has been moved by the force of the water that just hit the wall of FLOODBAGs. The tracking station has concluded that this particular FLOODBAG is out of the wall, by comparing the location of this FLOODBAG to the locations of others that are within the wall. The tracking station is broadcasting a warning that the wall has been breached.

FIG. 7 is a FLOODBAG of the present invention, with a remediation pouch, being filled with wood chips in a factory. The remediation pouch contains a type of bacteria that is useful for absorbing hydrocarbons.

### DETAILED DESCRIPTION OF THE DRAWINGS

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

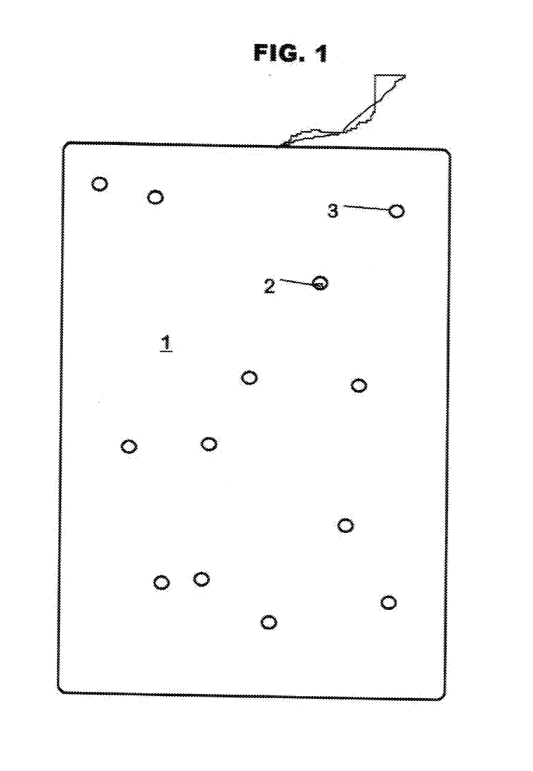

FIG. 1 shows one of the “FLOODBAGs” of an embodiment of the present invention, while in the “dry” state. The absorption holes (3) are visible in the outer casing. Parts of compressed wood pellets can be seen through the absorption holes. The FLOODBAG is sealed and does not take up as much volume as it would take up if it was immersed in water. A cord by which the FLOODBAG was tied can be seen on the top of the FLOODBAG. The FLOODBAG is laid flat and viewed from above.

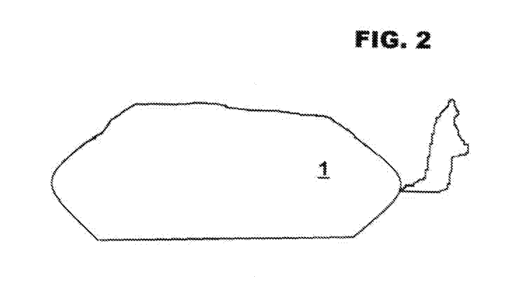

FIG. 2 shows one of the “FLOODBAGs” of the first embodiment of the present invention, on its side, with water having been absorbed into the water-absorbing pellets. Oil is not absorbed into the water-absorbing pellets, because the oil molecules are too large to penetrate the extremely hard, compacted surface of the pellets. The absorption holes in this version of the first embodiment of the invention are too small to be visible. A cord by which the FLOODBAG was tied can be seen on the top of the FLOODBAG (which is lying on its side).

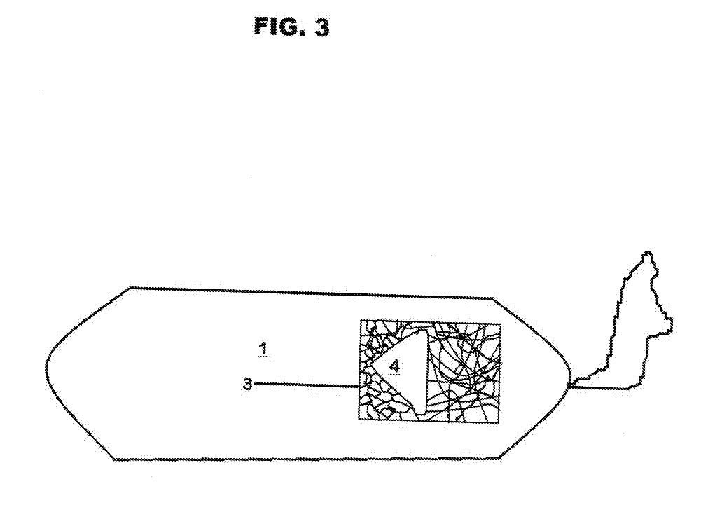

FIG. 3 is a cut-away view of one of the “FLOODBAG” of the first embodiment of the present invention after it has absorbed water. The viewer can see a large number of water-absorbing pellets inside the FLOODBAG. The viewer can also see a small oleophilic interior component inside the FLOODBAG (Note that oleophilic interior components can be bigger than this, and shaped differently from this).

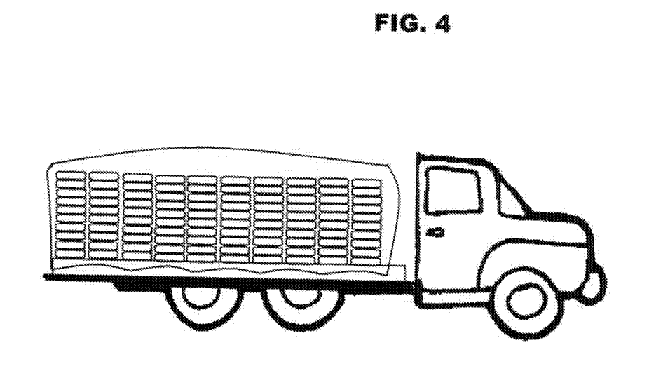

FIG. 4 shows several stacks of the FLOODBAGs, covered by a plastic covering, on a truck ready for transport. The FLOODBAGs are easier to transport than sandbags.

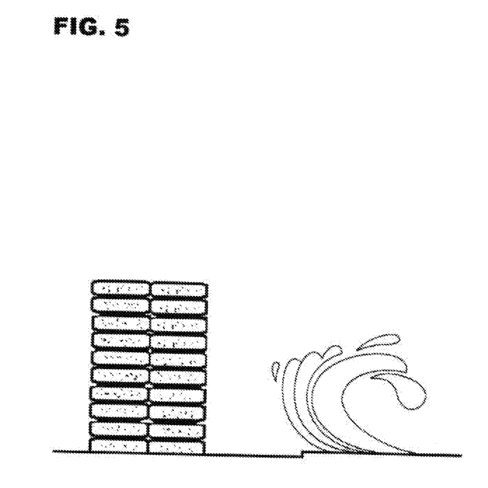

FIG. 5 is a group of FLOODBAGs of the invention, in position to stop an ongoing spill of water. The FLOODBAGs are stacked in a wall, and will absorb water when the spill hits them. The viewer can see the absorption holes of each FLOODBAG.

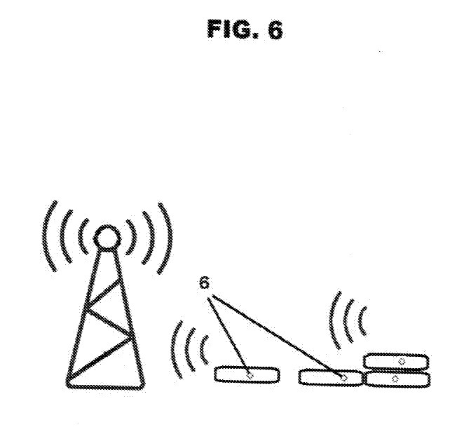

FIG. 6 shows a stack of the FLOODBAGs of the present invention, and shows the direction of information the tracking chips broadcast, so that the base station can determine the location of the tracking chips relative to each other, and whether each tracking chip (And the attached FLOODBAG) is in its desired position.

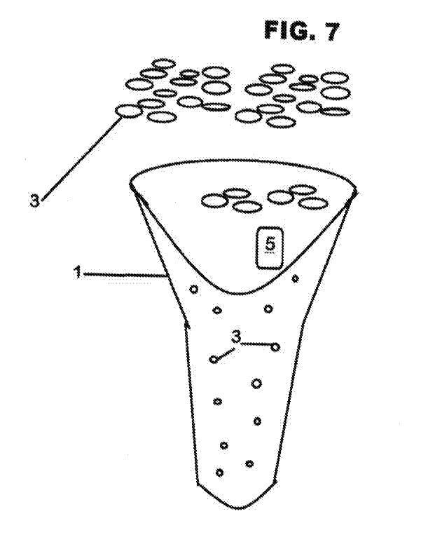

FIG. 7 shows a FLOODBAG being assembled, and in this case the FLOODBAG also has a remediation pouch. The FLOODBAG is open through one opening and wood pellets are being poured in. The FLOODBAG will next be closed, and sealed. The remediation pouch can be seen inside the FLOODBAG.

1. An apparatus for absorbing water, said apparatus comprising an outer covering (1) and, water-absorbing pellets (2),
wherein said outer covering is flexible, and hollow, creating a hollow interior space inside said outer covering, and where said outer covering is sealed with said interior space inside said outer covering;
wherein said outer covering further comprises absorption holes (3) which are holes in said outer covering;
and where said water-absorbing pellets (2) are inside the hollow interior of said outer covering;
and where said water-absorbing pellets (2), when dry, are too large to fit through said absorption holes (3);
and where said water-absorbing pellets (2) are comprised of compressed wood, that expands when placed in contact with water.

2. The apparatus of claim 1, further comprising that inside said interior space, along with said water-absorbing pellets (2) are solid chunks of one or more types of water-absorbing polymer, when said chunks of one or more types of water-absorbing polymer are too large to fit through said absorption holes (3).

3. The apparatus of claim 1, further comprising an oleophilic interior component, which is capable of absorbing hydrocarbon molecules, and which is located inside the hollow interior of said outer covering, and which is of sufficient size that said oleophilic interior component is too large to fit through said absorption holes.

4. The apparatus of claim 3, further comprising that said oleophilic interior component is comprised of polypropylene.

5. The apparatus of claim 3, further comprising that said outer covering is comprised of polypropylene.

6. The apparatus of claim 3, further comprising that said compressed wood chips are compressed sufficiently that the volume of said compressed wood chips, after said compressed wood chips were compressed, is less than 25% of the volume of said compressed wood chips before said compressed wood chips were compressed.

7. The apparatus of claim 3, further comprising that said compressed wood chips are comprised of pine wood.

8. The apparatus of claim 3, further comprising that said apparatus includes a non-flexible stiffener in the interior of said outer covering.

9. The apparatus of claim 3, further comprising that said apparatus includes a glow-in the-dark marking on the outer surface of said outer covering.

10. The apparatus of claim 3, further comprising that said apparatus includes a chip which is capable of broadcasting a signal, wherein said signal can be either directly or indirectly relayed to a monitoring station, and said monitoring station can determine the location of said chip from data pertaining to said signal.

11. The apparatus of claim 3, further comprising that said apparatus includes, on the outer surface of said outer covering, a means of connecting to other examples of said apparatus.

12. The apparatus of claim 11, further comprising that said means of connecting is a grommet and a fastener, wherein said fastener can be placed through the grommet of another example of said apparatus, and the fastener of another example of said apparatus can be placed into said grommet.

13. The apparatus of claim 11, further comprising that said means of connecting is a zip-tie feature, which can be tied to the zip-tie feature of another example of the apparatus of claim 10, and additionally comprising that said means of connecting does not open said outer covering.

14. The apparatus of claim 3, further comprising one or more remediation pouches, located inside said outer covering, wherein each said remediation pouch comprises a remediation pouch wall, which surrounds a sample of an agent;
said remediation pouch further comprising that exposure to water causes the wall of said remediation pouch to disintegrate, releasing said agent.

15. The apparatus of claim 14, further comprising that said agent is a chemical which is capable of binding to one or more metals when said chemical and said metal are dissolved in water.

16. The apparatus of claim 14, further comprising that said agent is a sample of a species of organism capable of binding to, absorbing, or removing a specific impurity from water.

17. The apparatus of claim 3, further comprising, inside the interior space created by said outer covering, a mat for cleaning a liquid spill on a surface, said mat comprising;
a flexible, liquid-permeable outer shell having a top side, a bottom side, and a peripheral edge, top side and bottom side defining an interior space therebetween, the top and bottom sides mutually fastened at fastening areas so that the interior space is segregated into a plurality of compartments, a plurality of inner sections each formed of a flexible liquid permeable material, wherein each said compartment contains only one of said inner sections, and wherein each inner section retains an absorbent material therein, the outer shell having a generally flat configuration; whereby when the mat comes in contact with liquid spill such that the liquid permeates the outer shell and is absorbed by the absorbent material.

18. The apparatus of claim 3, further comprising that said water-absorbing pellets inside the interior space include some water-absorbing pellets that are deliberately compacted to a different degree from other water-absorbing pellets in said interior space.

19. The apparatus of claim 3, further comprising that said apparatus includes a stiffener, and further comprising that said apparatus serves as a mouse pad.

20. The apparatus of claim 3, further comprising that said apparatus includes a medallion, said medallion further comprising a QR Code, said QR code further comprising information about one or more of the following;
a. the types of water-absorbing pellets and other items inside said interior space,
b. the existence and content of any remediation pouches that are part of said apparatus,
c. the identity of any specific intrusion of water that said apparatus was created to absorb.

21. A process for creating an apparatus that is capable of fully or partially absorbing intrusions of water, said process comprising;
determining the contents of the water which will be part of a threatened or actual intrusion,
placing specially designed apparatus with needed contents in a place where said apparatus can fully or partially absorb said intrusion,
having previously determined the needed contents for said apparatus, to ensure that said apparatus is designed to absorb the contents of the water that will be part of said threatened or actual intrusion, based on the following criteria;
a. the degree to which the wood pellets that are water-absorbing pellets, inside the interior space in said apparatus are compacted;
b. the nature and contents of the remediation pouches included in said apparatus;
c. whether the user needs to monitor the exact location of the apparatus to determine whether a breach in a barrier has happened;
d. the types of wood comp g the water-absorbing pellets, inside the apparatus;
e. whether or not said apparatus includes an oleophilic interior component, and, if so, what type of oleophilic interior component said apparatus includes;
said apparatus comprising an outer covering (1) and, water-absorbing pellets (2),
wherein said outer covering is flexible, and hollow, creating a hollow interior space inside said outer covering, and where said outer covering is sealed with said interior space inside said outer covering;
wherein said outer covering further comprises absorption holes (3) which are holes in said outer covering;
and where said water-absorbing pellets (2) are inside the hollow interior of said outer covering;
and where said water-absorbing pellets (2), when dry, are too large to fit through said absorption holes (3);
and where said water-absorbing pellets (2) are comprised of compressed wood, that expands when placed in contact with water;

21. The process of claim 21, further comprising that the water-absorbing pellets include wood pellets that are deliberately compacted to different degrees, which are mixed together before being placed inside said apparatus, or wood pellet of different types of wood, which are mixed together before being placed inside said apparatus.

22. A process for fully or partially absorbing a threatened or actual intrusion of water, said process comprising;
providing one or more examples of an apparatus for absorbing water, said apparatus comprising an outer covering (1) and, water-absorbing pellets (2),
wherein said outer covering is flexible, and hollow, creating a hollow interior space inside said outer covering, and where said outer covering is sealed with said interior space inside said outer covering;
wherein said outer covering further comprises absorption holes (3) which are holes in said outer covering;
and where said water-absorbing pellets (2) are inside the hollow interior of said outer covering;
and where said water-absorbing pellets (2), when dry, are too large to fit through said absorption holes (3);
and where said water-absorbing pellets (2) are comprised of compressed wood, that expands when placed in contact with water;
deploying said apparatus in the expected path of said threatened or actual inundation.

23. The process of claim 22, said process further comprising providing one or more examples of said apparatus;
and further providing a means for said one or more examples of said apparatus to be fastened together.

24. A process for creating an apparatus for fully or partially absorbing a threatened or actual intrusion of water; said process comprising;
providing a flexible, and hollow outer covering (1) with a hollow interior space inside said outer covering;
wherein said outer covering further comprises absorption holes (3) which are holes in said outer covering;
said method further comprising;
compressing wood pellets to create, water-absorbing pellets (2), where said water-absorbing pellets (2), when dry, are too large to fit through said absorption holes (3);
placing said water-absorbing pellets inside said interior space;
closing any opening in said outer covering except for said absorption holes;
placing said outer covering in a place where said outer covering, including said water-absorbing pellets, will be in the path of said actual or threatened inundation of water.

25. The method of claim 24, further comprising placing an oleophilic interior component inside said outer covering before closing any opening in said outer covering except for said absorption holes.

26. The method of claim 24, further comprising providing a method for multiple said outer coverings to be fastened to each other.
